(19) United States
(12) Patent Application Publication
(10) Pub. No.: US 2025/0226717 A1
(43) Pub. Date: Jul. 10, 2025

(54) STATOR AND MOTOR

(71) Applicant: DENSO CORPORATION, Kariya-city (JP)

(72) Inventor: Ryosuke MIZUNO, Kariya-city (JP)

(73) Assignee: DENSO CORPORATION, Kariya-city (JP)

(21) Appl. No.: 19/088,275

(22) Filed: Mar. 24, 2025

Related U.S. Application Data
(63) Continuation of application No. PCT/JP2023/034266, filed on Sep. 21, 2023.

(30) Foreign Application Priority Data
Sep. 22, 2022 (JP) 2022-151612

(51) Int. Cl. H02K 3/52

(52) U.S. Cl. CPC H02K 3/522; H02K 2203/12; H02K 2213/03

(57) ABSTRACT

A stator includes a stator core, windings and insulators. The stator core has a plurality of teeth. The windings are wound respectively around the teeth in a concentrated winding manner. Each of the insulators is interposed between the stator core and a corresponding one of the windings. Moreover, each of the insulators has a tooth covering part that covers necessary portions of a corresponding one of the teeth. The tooth covering part has a tooth end face covering portion, a pair of side face covering portions, and curved corners. Each of the curved corners is configured to satisfy: B/4<R<B·3/4; and B/8<H<B/2, where B is a tooth width in a width direction of the corresponding tooth, R is a radius of curvature of an outer curved surface of the curved corner, and H is a curved height of the curved corner.

### CROSS-REFERENCE TO RELATED APPLICATIONS

The present application is a continuation application of International Application No. PCT/JP2023/034266 filed on Sep. 21, 2023, which is based on and claims priority from Japanese Patent Application No. 2022-151612 filed on Sep. 22, 2022. The entire contents of these applications are incorporated by reference into the present application.

### BACKGROUND

### 1 Technical Field

The present disclosure relates to stators and motors.

### 2 Description of Related Art

In a stator included in a motor, windings are wound around teeth of a stator core to form coils. Moreover, to prevent direct contact between the stator core and the windings, those portions of the stator core which may come into contact with the windings are covered with insulators that are formed of an electrically insulative resin. In terms of improving the space factor of the windings mounted to the stator core, it is preferable to minimize outward bulging of the windings when they are wound around the teeth. To cope with this problem, there is known a technique of adding, to the insulators interposed between the stator core and the windings, a configuration for suppressing bulging of the windings toward the winding outside which may occur when they are wound around the teeth (see, for example, Japanese Patent Application Publication No. JP 2018-207717 A).

### SUMMARY

One of the measures for minimizing the size of a motor is to suppress increase in the size of the stator in an axial direction thereof. Moreover, to suppress increase in the size of the stator in the axial direction, it is necessary to configure the stator so that the windings, which are mounted to the teeth of the stator core, do not protrude significantly from axial end faces of the stator core.

The present disclosure has been accomplished in view of the above circumstances.

According to an aspect of the present disclosure, there is provided a stator which includes: a stator core having a plurality of teeth each extending in a radial direction; windings wound respectively around the teeth of the stator core in a concentrated winding manner to form coils respectively on the teeth; and insulators each of which is interposed between the stator core and a corresponding one of the windings to prevent direct contact between the corresponding winding and the stator core. Moreover, each of the insulators has a tooth covering part that covers necessary portions of a corresponding one of the teeth of the stator core. The tooth covering part has: a tooth end face covering portion that covers an axial end face of the corresponding tooth in an axial direction of the stator core; a pair of side face covering portions that respectively cover a pair of side surfaces of the corresponding tooth; and curved corners each of which is located between the tooth end face covering portion and an adjacent one of the side face covering portions and functions as a contact portion to make contact with the corresponding winding. Each of the curved corners is configured to satisfy: B/4<R<B·3/4; and B/8<H<B/2, where B is a tooth width in a width direction of the corresponding tooth, R is a radius of curvature of an outer curved surface of the curved corner, and H is a curved height of the curved corner.

According to another aspect of the present disclosure, there is provided a motor which includes a stator and a rotor. The stator includes: a stator core having a plurality of teeth each extending in a radial direction; windings wound respectively around the teeth of the stator core in a concentrated winding manner to form coils respectively on the teeth; and insulators each of which is interposed between the stator core and a corresponding one of the windings to prevent direct contact between the corresponding winding and the stator core. The rotor is configured to be driven under a rotating magnetic field, which is generated in the stator by supply of electric power to the stator, to rotate. Moreover, each of the insulators of the stator has a tooth covering part that covers necessary portions of a corresponding one of the teeth of the stator core. The tooth covering part has: a tooth end face covering portion that covers an axial end face of the corresponding tooth in an axial direction of the stator core; a pair of side face covering portions that respectively cover a pair of side surfaces of the corresponding tooth; and curved corners each of which is located between the tooth end face covering portion and an adjacent one of the side face covering portions and functions as a contact portion to make contact with the corresponding winding. Each of the curved corners is configured to satisfy: B/4<R<B·3/4; and B/8<H<B/2, where B is a tooth width in a width direction of the corresponding tooth, R is a radius of curvature of an outer curved surface of the curved corner, and H is a curved height of the curved corner.

In the above-described stator and motor, between the stator core and the windings, there are interposed the insulators that have a function of preventing direct contact between the stator core and the windings. Each of the insulators has, as contact portions for making contact with the corresponding winding, the curved corners each of which is located between the tooth end face covering portion and the adjacent side surface covering portion. The curved corners are those portions of the insulator with which the corresponding winding makes contact for the mounting thereof, i.e., those portions of the insulator which function as fulcrums against which the corresponding winding is bent during the winding thereof. Moreover, each of the curved corners is configured to satisfy: B/4<R<B·3/4; and B/8<H<B/2, where B is the tooth width, R is the radius of curvature of the outer curved surface of the curved corner, and H is the curved height of the curved corner. Consequently, it becomes possible to suitably suppress both the winding lift amount in the width direction of the corresponding tooth and the coil end height in the axial direction of the stator core (see FIG. 5). In other words, in the stator, it becomes possible to suitably suppress both bulging of the windings, which are mounted to the teeth of the stator core, toward the winding outside and the protruding height of the windings from the axial end faces of the stator core.

### BRIEF DESCRIPTION OF THE DRAWINGS

FIG. 1 is a configuration diagram of a motor which includes a stator according to an embodiment.

FIG. 2 is a perspective view showing a tooth of the stator according to the embodiment.

FIG. 3 is a cross-sectional view showing the tooth of the stator according to the embodiment.

FIG. 4 is a cross-sectional view showing an insulator mounted to the tooth of the stator according to the embodiment.

FIG. 5 is a correlation diagram for examining the wound state of windings of the stator according to the embodiment.

FIG. 6 is a cross-sectional view showing an insulator mounted to a tooth of a stator according to a modification.

FIG. 7 is a cross-sectional view showing an insulator mounted to a tooth of a stator according to another modification.

FIG. 8 is a cross-sectional view showing an insulator mounted to a tooth of a stator according to another modification.

FIG. 9 is a cross-sectional view showing an insulator mounted to a tooth of a stator according to another modification.

FIG. 10 is a cross-sectional view showing an insulator mounted to a tooth of a stator according to another modification.

### DESCRIPTION OF EMBODIMENTS

Hereinafter, an embodiment of a stator and a motor will be described.

### (Configuration of Motor M)

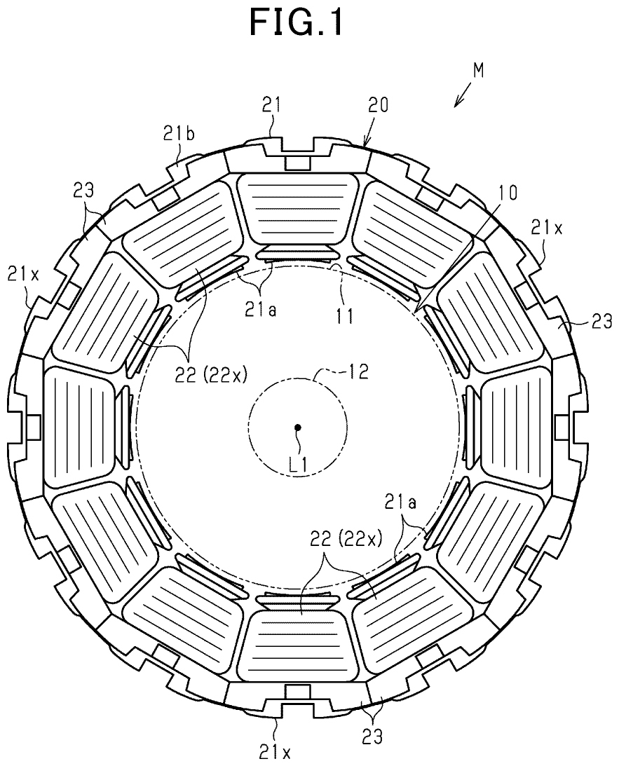

As shown in FIG. 1, a motor M according to the present embodiment includes a rotor 10 that is rotatably supported, and a stator 20 that is formed in a substantially annular shape and arranged radially outside the rotor 10. Upon generation of a rotating magnetic field in the stator 20 by supply of electric power to the stator 20, the rotor 10 is driven under the rotating magnetic field to rotate.

### (Configuration of Rotor 10)

In the present embodiment, the rotor 10 includes a rotor main body 11 and a rotating shaft 12. The rotor main body 11, the detailed configuration of which is not shown in the drawings, may be configured as being of a surface permanent magnet type in which permanent magnets are fixed to an outer circumferential surface of a rotor core, or of an interior permanent magnet type in which permanent magnets are embedded in a radially inner portion of a rotor core. Moreover, the rotor 10 may have, for example, ten or fourteen magnetic poles formed by the permanent magnets.

### (Configuration of Stator 20)

In the present embodiment, the stator 20 includes a stator core 21 formed of a magnetic metal, a plurality of coils 22 mounted to the stator core 21, and insulators 23 that are formed of an electrically insulative resin and interposed between the coils 22 and the stator core 21.

The stator core 21 has a substantially annular shape as a whole. The stator core 21 has a plurality of teeth 21a whose distal ends are oriented radially inward, and an annular part 21b that is located radially outside the teeth 21a to connect proximal ends of the teeth 21a to each other. More particularly, in the present embodiment, twelve teeth 21a are formed in the stator core 21. Each of the teeth 21a extends, in a substantially rectangular shape of a constant width, from its proximal end to its distal end. Moreover, in the present embodiment, the annular part 21b is formed by connecting a plurality of core parts 21x of the same shape, into which the stator core 21 is segmented for each of the teeth 21a, to one another in an annular shape. The annular part 21b functions as a back yoke. It should be noted that the annular part 21b may alternatively be formed as a single part without being divided in the circumferential direction.

The coils 22 are mounted respectively to the teeth 21a of the stator core 21. Each of the coils 22 is formed by winding a winding 22x around a corresponding one of the teeth 21a in a concentrated winding manner. The winding 22x may be formed of, for example, an enameled wire which is a solid wire formed of an electrically conductive material and having its outer surface coated integrally with an electrically insulative material. In the present embodiment, the number of the coils 22 mounted respectively to the teeth 21a of the stator core 21 is twelve; that is to say, the stator 20 has twelve coil magnetic poles.

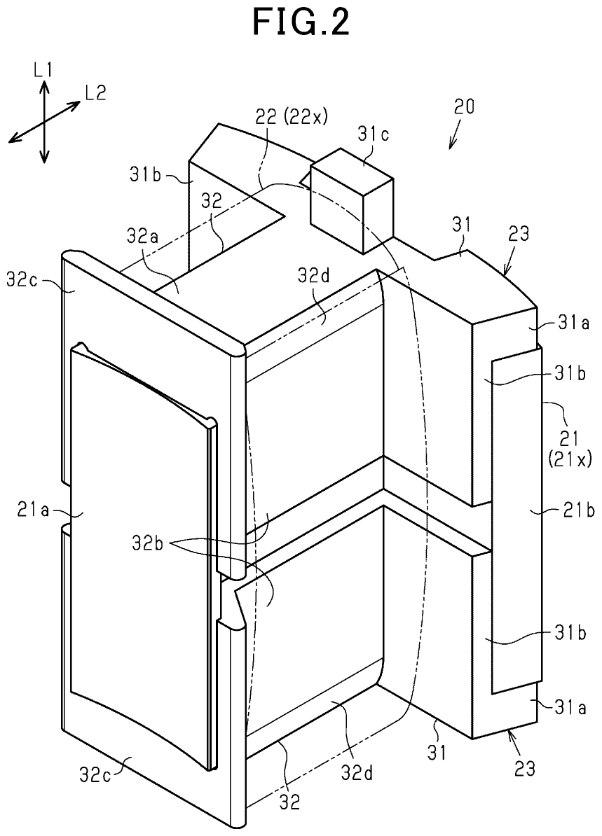

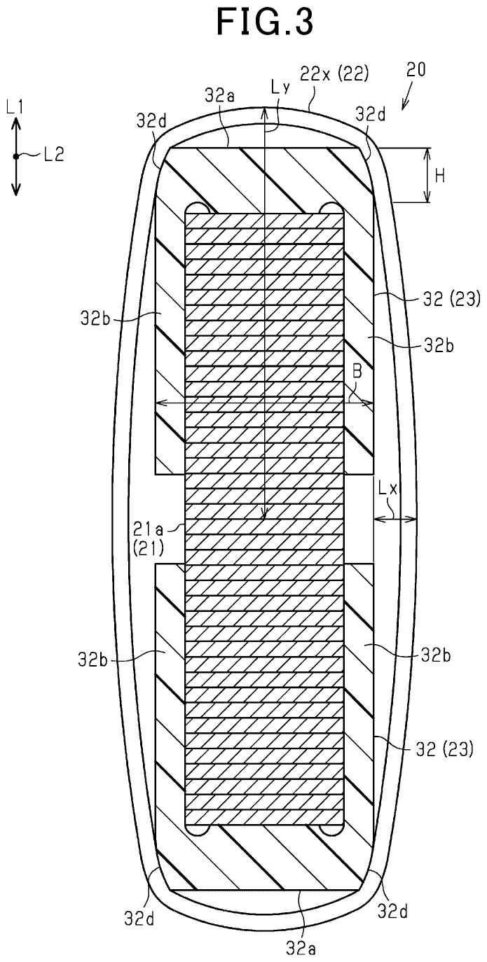

As shown in FIGS. 2 and 3, each of the insulators 23 is provided so as to be interposed between a corresponding one of the windings 22x, which respectively constitute the coils 22, and the stator core 21. Specifically, to prevent direct contact between the corresponding winding 22x and the stator core 21, each of the insulators 23 is provided so as to cover those portions of the stator core 21 which may come into contact with the corresponding winding 22x. In addition, both the shape of those portions of the insulators 23 around which the corresponding windings 22x are respectively wound and the manner in which the corresponding windings 22x are respectively wound around those portions of the insulators 23 will be described in detail later.

In the present embodiment, the insulators 23 are divided from each other so as to respectively correspond to the core parts 21x of the same shape into which the stator core 21 is segmented. Moreover, in the present embodiment, to each of the core parts 21x, there are mounted a corresponding pair of the insulators 23 of the same shape respectively from opposite axial sides of the stator core 21. It should be noted that the insulators 23 may alternatively be integrated into a single component without being divided in the circumferential direction. Moreover, it also should be noted that the insulators 23 may alternatively be formed integrally with the stator core 21.

The axial direction of the stator core 21 represents the motor axial direction which is common to the stator 20 and the rotor 10. The axial direction of the stator core 21 (i.e., the motor axial direction) is indicated by an arrow L1 in FIGS. 2 and 3. Moreover, a radial direction of the stator core 21 represents the direction in which one of the teeth 21a extends, and also represents the direction of the winding axis of one of the windings 22x. The direction in which one of the teeth 21a extends (i.e., the direction of the winding axis of one of the windings 22x) is indicated by an arrow L2 in FIGS. 2 and 3.

### (Detailed Configuration of Insulators 23)

In the present embodiment, the insulators 23 are divided from each other for each of the core parts 21x into which the stator core 21 is segmented. Moreover, in the present embodiment, to each of the core parts 21x, there are mounted a corresponding pair of the insulators 23 of the same shape respectively from opposite axial sides of the stator core 21.

Each of the insulators 23 has an annular-part covering part 31 that covers necessary portions of the annular part 21b of the stator core 21, and a tooth covering part 32 that covers necessary portions of the corresponding tooth 21a. The annular-part covering part 31 and the tooth covering parts 32 are integrally formed into one piece.

The annular-part covering part 31 includes an annular-part end face covering portion 31a that covers substantially the whole of an axial end face of the annular part 21b of the stator core 21, and a pair of inner covering portions 31b that cover substantially axial half of a pair of radially inner surfaces of the annular part 21b. The annular-part end face covering portion 31a and the inner covering portions 31b are integrally formed into one piece. Moreover, the annular-part end face covering portion 31a is perpendicular to the inner covering portions 31b. The annular-part end face covering portion 31a is arranged on an axial end face of the stator core 21, whereas the inner covering portions 31b extend in the axial direction of the stator core 21. The inner covering portions 31b are provided in a pair with respect to the single annular-part end face covering portion 31a. The pair of inner covering portions 31b respectively cover the pair of radially inner surfaces of the annular part 21b which are located respectively on opposite circumferential sides of the corresponding tooth 21a of the stator core 21. Moreover, a restriction protrusion 31c, which protrudes in the axial direction of the stator core 21, is provided to the annular-part end face covering portion 31a. The restriction protrusion 31c restricts outward movement of the corresponding winding 22x in the radial direction of the stator core 21.

The tooth covering part 32 includes a tooth end face covering portion 32a that covers substantially the whole of an axial end face of the corresponding tooth 21a of the stator core 21, and a pair of side face covering portions 32b that cover substantially axial half of a pair of circumferential side surfaces of the corresponding tooth 21a. The tooth end face covering portion 32a and the side face covering portions 32b are integrally formed into one piece. Moreover, the tooth end face covering portion 32a is perpendicular to the side face covering portions 32b. The tooth end face covering portion 32a is arranged on an axial end face of the stator core 21, whereas the side face covering portions 32b extend in the axial direction of the stator core 21. The side face covering portions 32b are provided in a pair with respect to the single tooth end face covering portion 32a. The pair of side face covering portions 32b respectively cover the pair of circumferential side surfaces of the corresponding tooth 21a of the stator core 21. Moreover, a restriction flange 32c, which protrudes continuously in the axial and circumferential directions of the stator core 21, is provided to the tooth end face covering portion 32a and the side face covering portions 32b. The restriction flange 32c restricts inward movement of the corresponding winding 22x in the radial direction of the stator core 21.

When each pair of the insulators 23 has been mounted to a corresponding one of the core parts 21x respectively from opposite axial sides of the stator core 21, the annular-part end face covering portions 31a and inner covering portions 31b of the annular-part covering parts 31 of the pair of the insulators 23 cover the whole of the necessary portions of the annular part 21b of the stator core 21. Moreover, the tooth end face covering portions 32a and side face covering portions 32b of the tooth covering parts 32 of the pair of the insulators 23 cover the whole of the necessary portions of the corresponding tooth 21a. Furthermore, the corresponding winding 22x is wound, with respect to the corresponding tooth 21a located between the restriction protrusions 31c and restriction flanges 32c of the pair of the insulators 23 in the radial direction of the stator core 21, on the tooth end face covering portions 32a and side face covering portions 32b of the tooth covering parts 32 of the pair of the insulators 23 which cover the periphery of the corresponding tooth 21a. In addition, in each of the insulators 23, the outer surface of the tooth end face covering portion 32a and the outer surfaces of the side face covering portions 32b are formed as flat surfaces that are perpendicular to each other.

When the corresponding winding 22x has been wound, as shown in FIG. 3 (i.e., as viewed in the direction of the winding axis of the corresponding winding 22x along which the corresponding tooth 21a extends), it is placed in contact with the corners between the tooth end face covering portions 32a and the side surface covering portions 32b. It should be noted that in FIG. 3, the corresponding winding 22x is illustrated in a simplified manner. There are four corners between the tooth end face covering portions 32a and the side surface covering portions 32b per turn of the corresponding winding 22x. In the present embodiment, all the four corners between the tooth end face covering portions 32a and the side surface covering portions 32b are formed as curved corners 32d. Each of the curved corners 32d has a curved shape that is convex outward. Moreover, each of the curved corners 32d keeps the curved shape continuously in the direction in which the corresponding tooth 21a extends, i.e., in the direction of the winding axis of the corresponding winding 22x. The curved corners 32d are those portions of the pair of the insulators 23 with which the corresponding winding 22x being wound makes contact, i.e., those portions of the pair of the insulators 23 which function as fulcrums against which the corresponding winding 22x is bent during the winding thereof. In addition, in a width direction of the corresponding tooth 21a which is perpendicular to both the axial and radial directions of the stator core 21, the pair of the insulators 23 (including the tooth end face covering portions 32a, the side surface covering portions 32b, and the curved corners 32d therebetween) are formed in an axisymmetric shape.

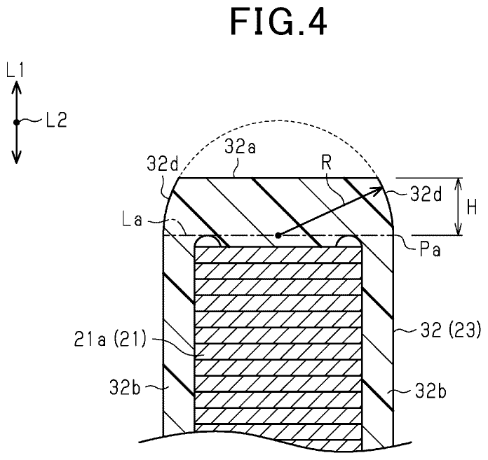

As shown in FIGS. 3 and 4, in the present embodiment, the curved corners 32d of the insulators 23 are set based on a tooth width B that includes the width of the corresponding tooth 21a and the thicknesses of a pair of the side surface covering portions 32b of the insulators 23.

In the present embodiment, for each of the curved corners 32d, the actual axial length of the curved corner 32d from a reference point Pa, which represents a boundary position between the curved corner 32d and the adjacent side surface covering portion 32b, to a boundary position between the curved corner 32d and the adjacent tooth end face covering portion 32a is defined as the curved height H. Moreover, in the present embodiment, the reference point Pa of the curved height H (i.e., the boundary position between the curved corner 32d and the adjacent side surface covering portion 32b) is set to a position slightly offset axially outward from an axial end face of the stator core 21. It should be noted that the reference point Pa of the curved height H (i.e., the boundary position between the curved corner 32d and the adjacent side surface covering portion 32b) may alternatively be set to the same position as the axial end face of the stator core 21, or to a position slightly offset axially inward from the axial end face of the stator core 21. Furthermore, in the present embodiment, the curved height H of the curved corner 32d is set to ¼ of the tooth width B, i.e., to (H=B/4).

Moreover, for each of the curved corners 32d, the radius of curvature R of an outer curved surface of the curved corner 32d is defined as the radius of a circle of curvature having its center on a reference line La that extends in the width direction of the corresponding tooth 21a through the reference point Pa. In the present embodiment, the radius of curvature R of the outer curved surface of the curved corner 32d is set to ½ of the tooth width B, i.e., to (R=B/2). In addition, in the present embodiment, with the radius of curvature R of the outer curved surfaces of the curved corners 32d set to ½ of the tooth width B, the outer curved surfaces of a pair of the curved corners 32d located respectively on opposite sides of the corresponding tooth 21a in the width direction thereof are on the same circumference. As mentioned above, the curved corners 32d are those portions of the insulators 23 with which the corresponding winding 22x makes contact for the mounting thereof, i.e., those portions of the insulators 23 which function as fulcrums against which the corresponding winding 22x is bent during the winding thereof.

### (Winding of Windings 22x Around Teeth 21a Via Insulators 23)

As shown in FIGS. 1 to 3, each of the windings 22x is wound around a corresponding one of the teeth 21a of the stator core 21 in a concentrated winding manner, thereby forming the coils 22 on the corresponding teeth 21a. Before winding the windings 22x around the corresponding teeth 21a, the insulators 23 are mounted to the stator core 21. The insulators 23 cover necessary portions of the stator core 2, such as the teeth 21a. The windings 22x are wound on the corresponding insulators 23 that are mounted so as to cover the corresponding teeth 21a and the like. The windings 22x are arranged in contact with the curved corners 32d of the corresponding insulators 23.

In the process of winding the windings 22x on the corresponding insulators 23, the windings 22x make contact with the outer curved surfaces of the curved corners 32d of the corresponding insulators 23 and are wound while being bent along the outer curved surfaces of the curved corners 32d. Specifically, in each turn of the continuous winding thereof, each of the windings 22x is wound with the four curved corners 32d of the corresponding insulators 23 functioning as the fulcrums for the bending thereof. On the other hand, although the windings 22x make contact with the curved corners 32d of the corresponding insulators 23, those portions of the windings 22x which are located between adjacent ones of the curved corners 32d bulge toward the winding outside. Consequently, those portions of the windings 22x which are located between adjacent ones of the curved corners 32d are placed out of contact with the tooth end face covering portions 32a and side face covering portions 32b of the tooth covering parts 32 of the corresponding insulators 23. In other words, the windings 22x are lifted from the outer surfaces of the tooth end face covering portions 32a and side face covering portions 32b of the tooth covering parts 32 of the corresponding insulators 23. Specifically, the windings 22x are lifted from adjacent ones of the curved corners 32d of the corresponding insulators 23 in a substantially curved shape. The degree of lift of the windings 22x increases from the curved corners 32d of the corresponding insulators 23 toward the middle positions between adjacent ones of the curved corners 32d.

Hereinafter, the relationship between the curved height H and the radius of curvature R of the curved corners 32d of the insulators 23 and the degree of lift of the windings 22x mounted by the winding thereof around the teeth 21a will be described using the winding lift amount Lx and the coil end height Ly. The winding lift amount Lx is defined, for each of the windings 22x, as the distances from the outer surfaces of the side surface covering portions 32b of the tooth covering parts 32 of the corresponding insulators 23 to those portions of the winding 22x which are lifted most in the width direction of the corresponding tooth 21a. On the other hand, the coil end height Ly is defined, for each of the windings 22x, as the distances from the center of the corresponding tooth 21a to those portions of the winding 22x which are lifted most from the outer surfaces of the tooth end face covering portions 32a of the tooth covering parts 32 of the corresponding insulators 23 in the axial direction of the stator core 21. The winding lift amount Lx and the coil end height Ly represent the degree of lift of the windings 22x from the corresponding teeth 21a. The changes in the winding lift amount Lx and the coil end height Ly with change in the curved height H relative to the tooth width B will be described below. In addition, the changes are those when the radius of curvature R is fixed to (R=B/2).

As shown in FIG. 5, as the curved height H of the curved corners 32d is gradually increased, the coil end height Ly also gradually increases in proportion to the curved height H. That is, increase in the curved height H has influence on increase in the coil end height Ly. However, in the present embodiment, the radius of curvature R of the curved corners 32d is set to (R=B/2); therefore, the outer surfaces of the tooth end face covering portions 32a remain flat until the curved height H becomes (H=B/2). That is, since the spaces above the flat outer surfaces of the tooth end face covering portions 32a can be utilized for arranging the winding 22x, it becomes possible to form the winding 22x into a bent shape that allows the winding 22x to be located closer than curved extension lines, which follow the outer curved surfaces of the curved corners 32d, to the flat outer surfaces of the tooth end face covering portions 32a (see FIGS. 3 and 4). Setting the curved height H to be smaller than (H=B/2), it is possible to effectively suppress the coil end height Ly. In the present embodiment, the curved height H is set to (H=B/4); consequently, it becomes possible to more effectively suppress the coil end height Ly.

As to the relationship between the curved height H of the curved corners 32d and the winding lift amount Lx, when the curved height H is set to (H=B/4) as in the present embodiment, the winding lift amount Lx is suppressed to the minimum value. With decrease in the curved height H below (H=B/4), the winding lift amount Lx increases. Moreover, the degree of the increase in the winding lift amount Lx is relatively high. On the other hand, with increase in the curved height H above (H=B/4), the winding lift amount Lx increases slightly until the curved height H becomes (H=B·5/16), but thereafter remains almost at a constant value.

### Operation According to Present Embodiment

Operation according to the present embodiment will be described.

In view of the changes in the winding lift amount Lx and the coil end height Ly with change in the curved height H of the curved corners 32d as described above, the inventor of the present application has determined that it is most preferable to set the curved height H to (H=B/4). Therefore, in the present embodiment, the curved height H of the curved corners 32d is set to (H=B/4), thereby suitably suppressing both the winding lift amount Lx and the coil end height Ly. That is, in the stator 20, it becomes possible to suitably suppress both bulging of the windings 22x, which are mounted to the teeth 21a of the stator core 21, toward the winding outside and the protruding height of the windings 22x from the axial end faces of the stator core 21. Consequently, it becomes possible to improve the space factor of the windings 22x in the stator 20 and achieve reduction in the size of the stator 20 and thus reduction in the size of the entire motor M.

It should be noted that although the curved height H is set to (H=B/4) in the present embodiment, both the winding lift amount Lx and the coil end height Ly can be sufficiently suppressed in a range A1 of (B·3/16<H<B·5/16). Moreover, it should also be noted that both the winding lift amount Lx and the coil end height Ly can be suppressed in a range A2 of (B/8<H<B/2). Accordingly, it is possible to configure the stator 20 with the curved height H set to be in the range A1 or in the range A2.

### Advantageous Effects Achievable According to Present Embodiment

Advantageous effects achievable according to the present embodiment will be described.

(1) In the present embodiment, each of the insulators 23 of the stator 20 has, as contact portions for making contact with the corresponding winding 22x, the curved corners 32d each of which is located between the tooth end face covering portion 32a and the adjacent side surface covering portion 32b. The curved corners 32d are those portions of the insulator 23 with which the corresponding winding 22x makes contact for the mounting thereof, i.e., those portions of the insulator 23 which function as fulcrums against which the corresponding winding 22x is bent during the winding thereof. Moreover, each of the curved corners 32d is configured to satisfy: B/4<R<B·3/4; and B/8<H<B/2, where B is the tooth width, R is the radius of curvature of the outer curved surface of the curved corner 32d, and H is the curved height of the curved corner 32d. More particularly, in the present embodiment, the radius of curvature R and the curved height H are set to the values considered to be most suitable among various values, i.e., set to (R=B/2) and (H=B/4). Consequently, it becomes possible to suitably suppress both the winding lift amount Lx in the width direction of the corresponding tooth 21a and the coil end height Ly in the axial direction of the stator core 21 (see FIG. 5). In other words, in the stator 20, it becomes possible to suitably suppress both bulging of the windings 22x, which are mounted to the teeth 21a of the stator core 21, toward the winding outside and the protruding height of the windings 22x from the axial end faces of the stator core 21. As a result, it becomes possible to improve the space factor of the windings 22x in the stator 20 and achieve reduction in the size of the stator 20 and thus reduction in the size of the entire motor M.

(2) In the present embodiment, the radius of curvature R and the curved height H are set to the values considered to be most suitable among various values, i.e., set to (R=B/2) and (H=B/4). Consequently, it becomes possible to maximize the advantageous effects achievable as described above.

### Modifications

The present embodiment can be modified and implemented as follows. Moreover, the present embodiment and the following modifications can also be implemented in combination with each other to the extent that there is no technical contradiction between them.

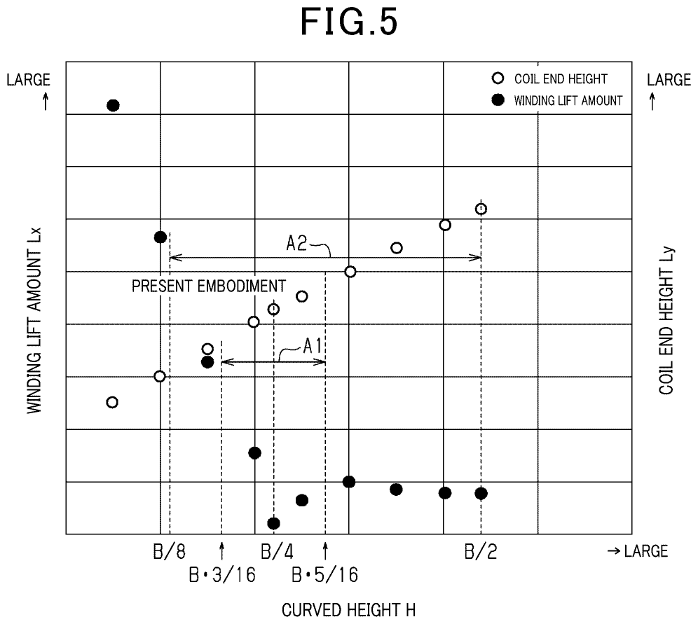

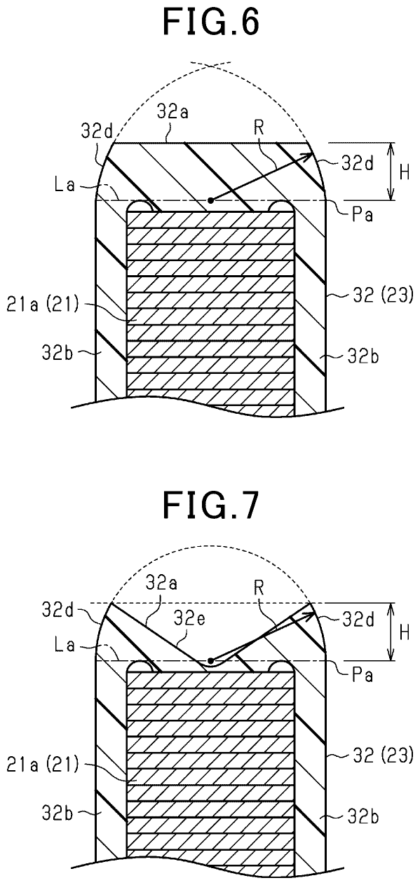

For each of the curved corners 32d of the insulators 23, the radius of curvature R of the outer curved surface of the curved corner 32d may be set to a value other than (R=B/2). In an example shown in FIG. 6, the radius of curvature R is set to (R>B/2). It is preferable to change the radius of curvature R as appropriate in a range of (B·3/8<R<B·5/8), where B is the tooth width. Moreover, it is sufficient to change the radius of curvature R as appropriate in a range of (B/4<R<B·3/4).

The shape of the insulators 23 may be changed as appropriate. For example, although each of the tooth end face covering portions 32a of the tooth covering parts 32 of the insulators 23 is configured to have a flat outer surface in the above-described embodiment, this configuration may be modified as appropriate.

For example, as shown in FIG. 7, for each of the tooth end face covering portions 32a of the tooth covering parts 32 of the insulators 23, a triangular recess 32e may be formed in the outer surface of the tooth end face covering portion 32a which is formed as a flat surface in the above-described embodiment. The recess 32e is recessed over the entire range of the tooth end face covering portion 32a in the width direction of the corresponding tooth 21a, and is recessed most at the center of the tooth end face covering portion 32a in the width direction of the corresponding tooth 21a.

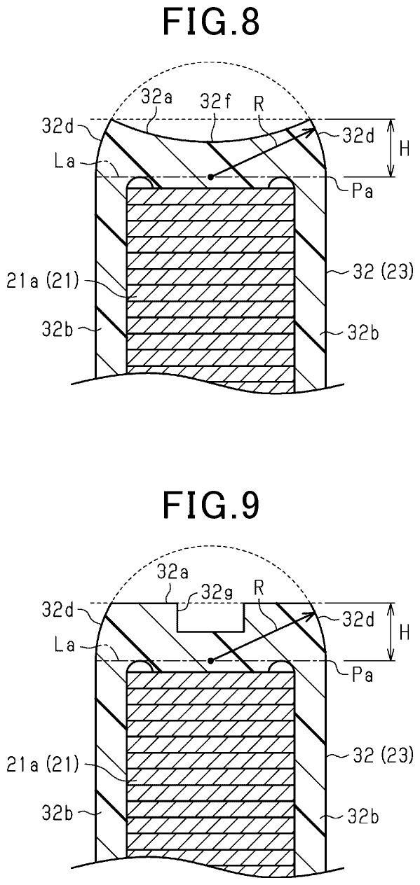

Moreover, as in an example shown in FIG. 8, for each of the tooth end face covering portions 32a of the tooth covering parts 32 of the insulators 23, an arc-shaped a recess 32f may be formed in the outer surface of the tooth end face covering portion 32a which is formed as a flat surface in the above-described embodiment. The recess 32f is also recessed over the entire range of the tooth end face covering portion 32a in the width direction of the corresponding tooth 21a, and is recessed most at the center of the tooth end face covering portion 32a in the width direction of the corresponding tooth 21a.

Furthermore, as in an example shown in FIG. 9, for each of the tooth end face covering portions 32a of the tooth covering parts 32 of the insulators 23, a rectangular recess 32g may be formed in part of the outer surface of the tooth end face covering portion 32a which is formed as a flat surface in the above-described embodiment. That is, the recess 32g has a width smaller than that of the entire outer surface of the tooth end face covering portion 32a. Moreover, the recess 32g is located at the center of the tooth end face covering portion 32a in the width direction of the corresponding tooth 21a. In addition, the recess 32g has a depth smaller than the thickness of the tooth end face covering portion 32a, i.e., smaller than the curved height H of the curved corners 32d.

In the above-described embodiment, each of the curved corners 32d of the insulators 23 has the outer curved surface thereof formed as a uniform curved surface. Alternatively, each of the curved corners 32d of the insulators 23 may have a composite outer curved surface composed of two or more outer curved surfaces which include a main outer curved surface having the radius of curvature R set as above and an outer curved surface formed continuously with the main outer curved surface.

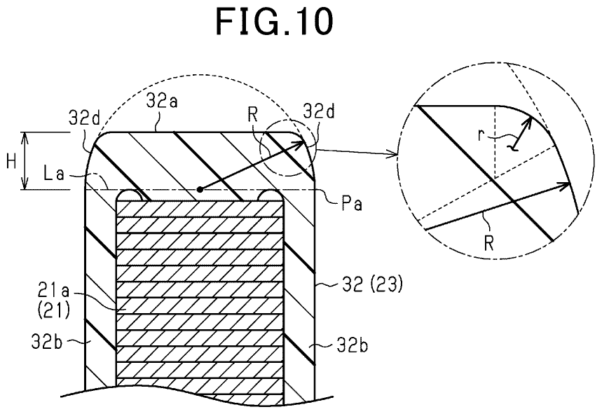

For example, as shown in FIG. 10, the main outer curved surface having the radius of curvature R set as above may be connected with the tooth end face covering portion 32a via an outer curved surface that is formed continuously with the main outer curved surface and has a radius of curvature r smaller than that of the main outer curved surface. In this case, the boundary between the curved corner 32d and the tooth end face covering portion 32a has a more smooth and continuous curved shape.

Besides the above modifications, the configuration of the stator 20 may be further modified as appropriate.

For example, in the above-described embodiment, the insulators 23 are mounted to the stator core 21 from both the axial sides of the stator core 21. Alternatively, insulators may be mounted to the stator core 21 from only one axial side of the stator core 21. Furthermore, insulators may be formed integrally with the stator core 21.

In the above-described embodiment, the stator core 21 has the segmented structure. Alternatively, the stator core 21 may have a one-piece structure without being segmented in the circumferential direction. Moreover, in the above-described embodiment, the stator core 21 has the teeth 21a whose distal ends are oriented radially inward. Alternatively, the stator core 21 may have teeth whose distal ends are oriented radially outward. In addition, the number of the teeth 21a, i.e., the number of the coil magnetic poles of the stator 20 may be changed as appropriate.

While the present disclosure has been described pursuant to the embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

### NOTES

The technical ideas that can be derived from the above-described embodiment and modifications are summarized below.

[1] A stator (20) comprising:
a stator core (21) having a plurality of teeth (21a) each extending in a radial direction;
windings (22x) wound respectively around the teeth of the stator core in a concentrated winding manner to form coils (22) respectively on the teeth; and
insulators (23) each of which is interposed between the stator core and a corresponding one of the windings to prevent direct contact between the corresponding winding and the stator core,
wherein
each of the insulators has a tooth covering part (32) that covers necessary portions of a corresponding one of the teeth of the stator core,
the tooth covering part has:
a tooth end face covering portion (32a) that covers an axial end face of the corresponding tooth in an axial direction of the stator core;
a pair of side face covering portions (32b) that respectively cover a pair of side surfaces of the corresponding tooth; and
curved corners (32d) each of which is located between the tooth end face covering portion and an adjacent one of the side face covering portions and functions as a contact portion to make contact with the corresponding winding,
each of the curved corners is configured to satisfy:

$$B / 4 < R < B \cdot 3 / 4 ; and$$

$$B / 8 < H < B / 2 ,$$

where B is a tooth width in a width direction of the corresponding tooth, R is a radius of curvature of an outer curved surface of the curved corner, and H is a curved height of the curved corner.

[2] The stator as set forth in the above note [1], wherein each of the curved corners of the insulators is configured to satisfy: B·3/16<H<B·5/16, where B is the tooth width in the width direction of the corresponding tooth, and H is the curved height of the curved corner.

[3] The stator as set forth in the above note [1], wherein each of the curved corners of the insulators is configured to satisfy: H=B/4, where B is the tooth width in the width direction of the corresponding tooth, and H is the curved height of the curved corner.

[4] The stator as set forth in any one of the above notes [1] to [3], wherein each of the curved corners of the insulators is configured to satisfy: R=B/2, where R is the radius of curvature of the outer curved surface of the curved corner, and B is the tooth width in the width direction of the corresponding tooth.

[5] The stator as set forth in any one of the above notes [1] to [4], wherein for each of the curved corners of the insulators, a main outer curved surface, which is the outer curved surface of the curved corner having the radius of curvature (R) set as above, is connected with the tooth end face covering portion via an outer curved surface that is formed continuously with the main outer curved surface and has a radius of curvature (r) smaller than that of the main outer curved surface.

[6] A motor (M) comprising:
a stator (20) including a stator core (21) having a plurality of teeth (21a) each extending in a radial direction, windings (22x) wound respectively around the teeth of the stator core in a concentrated winding manner to form coils (22) respectively on the teeth, and insulators (23) each of which is interposed between the stator core and a corresponding one of the windings to prevent direct contact between the corresponding winding and the stator core; and
a rotor (10) configured to be driven under a rotating magnetic field, which is generated in the stator by supply of electric power to the stator, to rotate,
wherein
each of the insulators of the stator has a tooth covering part (32) that covers necessary portions of a corresponding one of the teeth of the stator core,
the tooth covering part has:
a tooth end face covering portion (32a) that covers an axial end face of the corresponding tooth in an axial direction of the stator core;
a pair of side face covering portions (32b) that respectively cover a pair of side surfaces of the corresponding tooth; and
curved corners (32d) each of which is located between the tooth end face covering portion and an adjacent one of the side face covering portions and functions as a contact portion to make contact with the corresponding winding,
each of the curved corners is configured to satisfy:

$$B / 4 < R < B \cdot 3 / 4 ; and$$

$$B / 8 < H < B / 2 ,$$

where B is a tooth width in a width direction of the corresponding tooth, R is a radius of curvature of an outer curved surface of the curved corner, and H is a curved height of the curved corner.

What is claimed is:

1. A stator comprising:
a stator core having a plurality of teeth each extending in a radial direction;
windings wound respectively around the teeth of the stator core in a concentrated winding manner to form coils respectively on the teeth; and
insulators each of which is interposed between the stator core and a corresponding one of the windings to prevent direct contact between the corresponding winding and the stator core,
wherein
each of the insulators has a tooth covering part that covers necessary portions of a corresponding one of the teeth of the stator core,
the tooth covering part has:
a tooth end face covering portion that covers an axial end face of the corresponding tooth in an axial direction of the stator core;
a pair of side face covering portions that respectively cover a pair of side surfaces of the corresponding tooth; and
curved corners each of which is located between the tooth end face covering portion and an adjacent one of the side face covering portions and functions as a contact portion to make contact with the corresponding winding,
each of the curved corners is configured to satisfy:
$$B / 4 < R < B \cdot 3 / 4 ; and$$
$$B / 8 < H < B / 2 ,$$
where B is a tooth width in a width direction of the corresponding tooth, R is a radius of curvature of an outer curved surface of the curved corner, and H is a curved height of the curved corner.

2. The stator as set forth in claim 1, wherein each of the curved corners of the insulators is configured to satisfy: B·3/16<H<B·5/16, where B is the tooth width in the width direction of the corresponding tooth, and H is the curved height of the curved corner.

3. The stator as set forth in claim 1, wherein each of the curved corners of the insulators is configured to satisfy: H=B/4, where B is the tooth width in the width direction of the corresponding tooth, and H is the curved height of the curved corner.

4. The stator as set forth in claim 1, wherein each of the curved corners of the insulators is configured to satisfy: R=B/2, where R is the radius of curvature of the outer curved surface of the curved corner, and B is the tooth width in the width direction of the corresponding tooth.

5. The stator as set forth in claim 1, wherein for each of the curved corners of the insulators, a main outer curved surface, which is the outer curved surface of the curved corner having the radius of curvature set as above, is connected with the tooth end face covering portion via an outer curved surface that is formed continuously with the main outer curved surface and has a radius of curvature smaller than that of the main outer curved surface.

6. A motor comprising:
a stator including a stator core having a plurality of teeth each extending in a radial direction, windings wound respectively around the teeth of the stator core in a concentrated winding manner to form coils respectively on the teeth, and insulators each of which is interposed between the stator core and a corresponding one of the windings to prevent direct contact between the corresponding winding and the stator core; and
a rotor configured to be driven under a rotating magnetic field, which is generated in the stator by supply of electric power to the stator, to rotate,
wherein
each of the insulators of the stator has a tooth covering part that covers necessary portions of a corresponding one of the teeth of the stator core,
the tooth covering part has:
a tooth end face covering portion that covers an axial end face of the corresponding tooth in an axial direction of the stator core;
a pair of side face covering portions that respectively cover a pair of side surfaces of the corresponding tooth; and
curved corners each of which is located between the tooth end face covering portion and an adjacent one of the side face covering portions and functions as a contact portion to make contact with the corresponding winding,
each of the curved corners is configured to satisfy:
$$B / 4 < R < B \cdot 3 / 4 ; and$$
$$B / 8 < H < B / 2 ,$$
where B is a tooth width in a width direction of the corresponding tooth, R is a radius of curvature of an outer curved surface of the curved corner, and H is a curved height of the curved corner.
